(19) United States
(12) Patent Application Publication
(10) Pub. No.: US 2020/0031310 A1
(43) Pub. Date: Jan. 30, 2020

(54) RESTRAINT SYSTEM AND METHOD FOR OPERATING SAME

(71) Applicant: ADIENT AEROSPACE LLC, Kirkland, WA (US)

(72) Inventors: Wolfgang KREUTZ, Reichenbach-Steegen (DE); Michael BURR, Langwieden (DE)

(73) Assignee: ADIENT AEROSPACE LLC, Kirkland, WA (US)

(21) Appl. No.: 16/497,757

(22) PCT Filed: Mar. 23, 2018
(86) PCT No.: PCT/US2018/023966

§ 371 Date: Sep. 25, 2019

(30) Foreign Application Priority Data
Apr. 3, 2017 (EP) 17164637.5

(51) Int. Cl. B60R 22/48; B60R 22/343; B64D 11/06

(52) U.S. Cl. CPC B60R 22/48; B60R 2022/4808; B64D 11/062; B60R 22/343

(57) ABSTRACT

The invention relates to a restraint system (11) for an aircraft seat (10), comprising a restraint belt (3) and a belt retractor (2) for winding up the restraint belt (3) and allowing the restraint belt (3) to be extracted, further comprising a blocking device (1) for blocking the belt retractor (2) such that the restraint belt (3) cannot be extracted, wherein the blocking device is connectable to a signal (S) used to issue audible and/or visual output (6) inviting passengers to fasten seat belts (3), wherein the blocking device (1) is configured to interact with the seat belt retractor (2) such that the seat belt retractor (2) prevents further extraction of the seat belt (3) while the signal (S) is active. Furthermore, the invention relates to a method for operating a restraint system.

### FIELD OF INVENTION

The invention relates to a restraint system for a seat, in particular for an aircraft seat, and to a method for operating a restraint system.

### DESCRIPTION OF THE RELATED ART

In commercial aircraft passenger seats, conventional static two-point seat belt restraint mechanisms are used which restrain the passenger in the seat. Automotive seat belt retractors with an inertia locking system (so-called emergency locking retractor (ELR)) are provided with an emergency locking mechanism for stopping extraction of the belt when an emergency situation of the vehicle is detected by an acceleration sensor. The occupant can change his position easily in conventional situations of the vehicle. ELR seat belt retractors with an inertia locking system as known from automotive seat belt restraint mechanisms are not used for commercial aircraft because the inertia latching does not work reliable in all aviation cases (e.g. turbulences).

A retractor provided with an automatic locking mechanism for automatically stopping an additional unwinding of the belt after the passenger has buckled up, is referred to as an automatic locking retractor (ALR). The occupant is always restrained securely by the seat belt, so that it is difficult to change position.

DE 91 14 939 U1 discloses a safety belt retractor with an electrical vehicle safety belt lock element which locks the safety belt retractor when a service break of the vehicle is operated.

DE 23 47 036 A1 discloses a vehicle safety belt with an automatic belt retractor device, wherein an unrolling movement can be blocked by a blocker which is sensitive to acceleration of the belt and/or the vehicle, wherein the blocker can additionally be operated by the service break of the vehicle.

DE 102 48 262 B3 discloses a safety system for a vehicle having a control system for controlling a belt spooler locking device with a belt shaft and a device for changing over between acceleration-dependent ELR operation and ALR operation, in which the belt can only be retracted and each extraction of the belt causes blocking of the belt shaft, especially for securing child seats. An electrical control element controlled by an externally triggered electric signal provided for actuating the changeover blocks the belt shaft in ALR mode and enables the control and locking system in ELR mode.

### SUMMARY OF THE INVENTION

It is an object of the present invention to provide an improved restraint system for a seat, in particular for an aircraft seat, and an improved method for operating a restraint system.

The object is achieved by a restraint system according to claim 1 and by a method according to claim 10.

Preferred embodiments of the invention are given in the dependent claims.

According to the invention, a restraint system for a seat, in particular an aircraft seat, comprises a restraint belt and a belt retractor for winding up the restraint belt and allowing the restraint belt to be extracted. The restraint system further comprises a blocking device for blocking the belt retractor such that the restraint belt cannot be further extracted, wherein the blocking device is connectable to a signal used to issue audible and/or visual output inviting passengers to fasten seat belts, wherein the blocking device is configured to interact with the seat belt retractor such that the seat belt retractor prevents further extraction of the seat belt while the signal is active.

Conventional seat belts in aircraft passenger seats are static pelvic restraint belts having a manually adjustable length but without a retractor for winding the belt up. Conventional retractors block extraction of the seat belts if a predefined acceleration of the seat belt during extraction is exceeded which is not permitted in aircraft as turbulences may subject the passengers to relatively small accelerations which would be insufficient to block belt extraction.

The restraint system according to the invention increases comfort by allowing the passenger to change positions when the signal used to issue audible and/or visual output inviting passengers to fasten seat belts are inactive while maintaining safety of the restraint system, in particular when applied to seat belts for aircraft passenger seats, regardless of whether they are pelvic restraint belts (two-point seat belt) or three-, four-, five- or more point seat belts.

In an exemplary embodiment, the seat belt retractor is an automatic locking retractor (ALR) configured to automatically stop an additional extraction of the belt after extraction of the belt has been stopped.

In an exemplary embodiment, the blocking device comprises a blocking element which keeps the seat belt retractor in an unlocked state so that the belt can be additionally extracted after extraction of the belt has been stopped as long as the blocking element is powered while the signal is inactive.

This increases comfort as opposed to conventional automatic locking retractors without the blocking device in which the belt is always retracted if loose so the passenger's space for movement is increasingly restricted. For example, with a conventional automatic locking retractor, the passenger would have to unbuckle before moving from a standard position into a comfort position or a lying position as this requires more belt length. Furthermore, the passenger could not change from the supine position into the lateral position without unbuckling. The belt will subject the passenger to discomfort as it permanently tends to retract and lock again. The passenger may consequentially not buckle up and will have to be woken up by the cabin crew to buckle up in case of turbulences. These problems may be avoided with the presently claimed restraint system. The passenger experiences more comfort while the signal is inactive without compromising safety while the signal is active or while the power is down as in these cases the ALR belt retractor is in its conventional mode of operation.

In an exemplary embodiment, the seat belt retractor is an emergency locking retractor (ELR) configured to stop extraction of the belt when an emergency situation is detected by an acceleration sensor sensitive to acceleration of the belt and/or the aircraft.

In an exemplary embodiment, the blocking device is configured to block the seat belt retractor when the signal is active so that the belt cannot be further extracted.

In an exemplary embodiment, the blocking device comprises a blocking element which keeps the seat belt retractor in an unlocked state so that the belt can be additionally extracted unless an emergency situation is detected by the acceleration sensor as long as the blocking element is powered while the signal is inactive.

In an exemplary embodiment, the blocking element is a solenoid.

In an exemplary embodiment, the signal is inverted and/or amplified before reaching the blocking element.

In an exemplary embodiment, the restraint belt is a pelvic restraint belt or a three-, four-, five- or more point belt.

According to another aspect of the invention, a method is provided for operating a restraint system for an aircraft seat, comprising a restraint belt and a belt retractor for winding up the restraint belt and allowing the restraint belt to be extracted, further comprising a blocking device for blocking the belt retractor such that the restraint belt cannot be extracted, wherein the blocking device is connectable to signal used to issue audible and/or visual output inviting passengers to fasten seat belts. In this method the blocking device is controlled to interact with the seat belt retractor such that the seat belt retractor prevents further extraction of the seat belt while the signal is active.

In an exemplary embodiment, the seat belt retractor is an automatic locking retractor configured to automatically stop an additional extraction of the belt after extraction of the belt has been stopped, wherein the blocking device comprises a blocking element which, while the signal is inactive, is powered so as to keep the seat belt retractor in an unlocked state so that the belt can be additionally extracted after extraction of the belt has been stopped.

In an exemplary embodiment, the seat belt retractor is an emergency locking retractor configured to stop extraction of the belt when an emergency situation is detected by an acceleration sensor sensitive to acceleration of the belt and/or the aircraft, wherein the blocking device blocks the seat belt retractor when the signal is active so that the belt cannot be further extracted.

### BRIEF DESCRIPTION OF THE DRAWINGS

The present invention will become more fully understood from the detailed description given herein below and the accompanying drawing which is given by way of illustration only, and thus, are not limitative of the present invention, and wherein:

FIG. 1 is a schematic view of a restraint system for an aircraft seat.

### DETAILED DESCRIPTION OF PREFERRED EMBODIMENTS

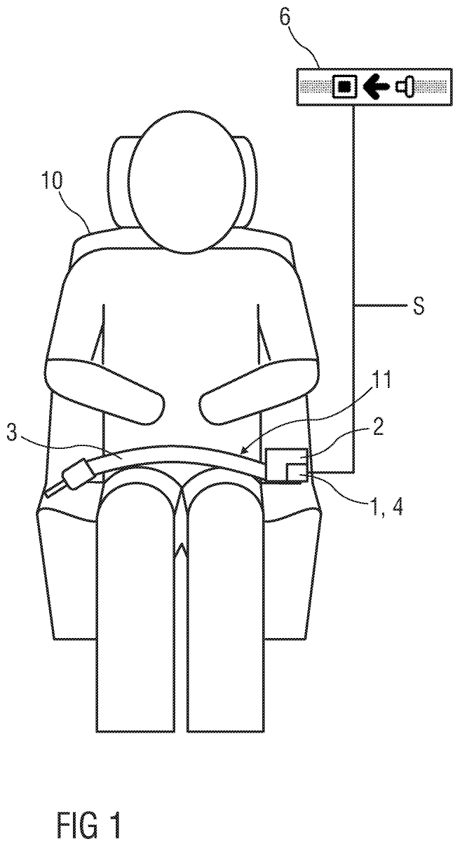

FIG. 1 is a schematic view of a passenger seat 10, in particular for an aircraft. A restraint system 11 is provided, comprising a blocking device 1, a seat belt retractor 2 and a restraint belt 3.

In a first embodiment, the seat belt retractor 2 is an automatic locking retractor (ALR) configured to automatically stop an additional unwinding of the belt 3 after a passenger has buckled up, i.e. the belt 3 has to be pulled out of the seat belt retractor 2 by the passenger. When the passenger stops pulling out the belt 3 and/or closes the belt buckle, the seat belt retractor 2 is blocked so that the belt 3 cannot be extracted further. Further extraction of the belt 3 can only be achieved by optionally releasing the belt buckle, ceasing to pull on the belt 3 and letting the seat belt retractor 2 pull the belt 3 back in and then pulling the belt 3 out again as far as desired.

The blocking device 1 comprises a blocking element 4, e.g. a solenoid, which keeps the seat belt retractor 2 in an unlocked state so that the belt 3 can be extracted further as long as the blocking element 4 is powered, i.e. fed a current. The blocking element 4 is electrically connected to a signal S used to issue audible and/or visual output 6 inviting the passengers to fasten seat belts 3, i.e. during take-off and during landing, such that the blocking element 4 is powered, i.e. fed a current, as long as the signal S is inactive. As soon as the signal S is active, the blocking element 4 is no longer powered and the automatic locking mechanism of the ALR seat belt retractor 2 is back in its conventional operational mode, i.e. it automatically stops an additional unwinding of the belt 3 after the passenger has fastened the seat belt 3. For this purpose, the signal S may be inverted and/or amplified before reaching the blocking element 4. Consequently, a power breakdown in the cabin of the aircraft also causes the automatic locking mechanism of the ALR seat belt retractor 2 to arrive back in its conventional operational mode.

In a second embodiment, the seat belt retractor 2 is an inertia locking retractor or emergency locking retractor (ELR), i.e. the extraction of the belt 3 is stopped when an emergency situation is detected by an acceleration sensor sensitive to acceleration of the belt 3 and/or the aircraft.

The blocking device 1 electrically connects the seat belt retractor 2 to a signal S used to issue audible and/or visual output 6 inviting the passengers to fasten seat belts 3, i.e. during take-off and during landing so that the seat belt retractor 2 is blocked when the signal S is active and that the seat belt retractor 2 is unblocked and in its conventional operational mode when the signal S is inactive.

For example, the blocking device 1 comprises a blocking element 4, e.g. a solenoid, which keeps the seat belt retractor 2 in an unlocked state so that the ELR seat belt retractor 2 is in its conventional operational mode, i.e. the extraction of the belt 3 is stopped when an emergency situation is detected by an acceleration sensor sensitive to acceleration of the belt 3 and/or the aircraft, and the belt 3 can be extracted further as long as the blocking element 4 is not powered while the signal S is inactive. As soon as the signal S is active, the blocking element 4 becomes powered and blocks the seat belt retractor 2 so that the belt 3 cannot be further extracted. For this purpose, the signal S may be amplified before reaching the blocking element 4. Consequently, a power breakdown in the cabin of the aircraft causes the automatic locking mechanism of the ELR seat belt retractor 2 to arrive back in its conventional operational mode. In an exemplary embodiment, the signal S may be inverted and/or amplified before reaching the blocking element 4 and the blocking element 4 may be configured to block the seat belt retractor 2 when not powered during a power breakdown or while the signal S is active and to unblock the seat belt retractor 2 when powered while the signal S is inactive.

### LIST OF REFERENCES

1 blocking device

2 seat belt retractor

3 belt

4 blocking element

6 output

10 passenger seat

11 restraint system

S signal

1. A restraint system for a seat, the restraint system comprising:
a restraint belt; and
a belt retractor for winding up the restraint belt and allowing the restraint belt to be extracted; and
a blocking device for blocking the belt retractor such that the restraint belt cannot be extracted, wherein the blocking device is connectable to a signal used to issue audible and/or visual output inviting passengers to fasten seat belts, wherein the blocking device is configured to interact with the seat belt retractor such that the seat belt retractor prevents further extraction of the seat belt while the signal is active.

2. The restraint system according to claim 1, wherein the seat belt retractor is an automatic locking retractor configured to automatically stop an additional extraction of the belt after extraction of the belt has been stopped.

3. The restraint system according to claim 2, wherein the blocking device comprises a blocking element which keeps the seat belt retractor in an unlocked state so that the belt can be additionally extracted after extraction of the belt has been stopped as long as the blocking element is powered while the signal is inactive.

4. The restraint system according to claim 1, wherein the seat belt retractor is an emergency locking retractor configured to stop extraction of the belt when an emergency situation is detected by an acceleration sensor sensitive to acceleration of the belt and/or acceleration of an aircraft with the restraint system.

5. The restraint system according to claim 4, wherein the blocking device is configured to block the seat belt retractor when the signal is active so that the belt cannot be further extracted.

6. The restraint system of claim 5, wherein the blocking device comprises a blocking element which keeps the seat belt retractor in an unlocked state so that the belt can be additionally extracted unless an emergency situation is detected by the acceleration sensor as long as the blocking element is powered while the signal is inactive.

7. The restraint system of claim 3, wherein the blocking element is a solenoid.

8. The restraint system of claim 7, wherein the signal is inverted and/or amplified before reaching the blocking element.

9. The restraint system of claim 3, wherein the signal is inverted and/or amplified before reaching the blocking element.

10. The restraint system of claim 1, wherein the restraint belt is a pelvic restraint belt or a three-, four-, five- or more point belt.

11. A method for operating a restraint system for an aircraft seat, the method comprising:
providing a restraint system comprising a restraint belt, a belt retractor for winding up the restraint belt and allowing the restraint belt to be extracted, and a blocking device for blocking the belt retractor such that the restraint belt cannot be extracted, wherein the blocking device is connectable to a signal used to issue audible and/or visual output inviting passengers to fasten seat belts, wherein the blocking device is configured to interact with the seat belt retractor such that the seat belt retractor prevents further extraction of the seat belt while the signal is active
connecting the blocking device to the signal used to issue audible and/or visual output inviting passengers to fasten seat belts; and
controlling the blocking device to interact with the seat belt retractor such that the seat belt retractor prevents further extraction of the seat belt while the signal is active.

12. The method of claim 11, wherein the seat belt retractor is an automatic locking retractor configured to automatically stop an additional extraction of the belt after extraction of the belt has been stopped, wherein the blocking device comprises a blocking element which, while the signal is inactive, is powered so as to keep the seat belt retractor in an unlocked state so that the belt can be additionally extracted after extraction of the belt has been stopped.

13. The method of claim 11, wherein the seat belt retractor is an emergency locking retractor configured to stop extraction of the belt when an emergency situation is detected by an acceleration sensor sensitive to acceleration of the belt and/or acceleration of an aircraft with the restraint system, wherein the blocking device blocks the seat belt retractor when the signal is active so that the belt cannot be further extracted.

14. The restraint system of claim 4, wherein the blocking element comprises a solenoid.

15. The restraint system of claim 5, wherein the blocking element comprises a solenoid.

16. The restraint system of claim 6, wherein the blocking element comprises a solenoid.
